(19) United States
(12) Patent Application Publication
(10) Pub. No.: US 2010/0238068 A1
(43) Pub. Date: Sep. 23, 2010

(54) RADAR DEVICE

(76) Inventors: Juergen Seidel, Esslingen (DE); Juergen Hasch, Stuttgart (DE); Ewald Schmidt, Ludwigsburg (DE)

Correspondence Address: KENYON & KENYON LLP, ONE BROADWAY, NEW YORK, NY, 10004, US

(21) Appl. No.: 12/670,361

(22) PCT Filed: Jul. 11, 2008
(86) PCT No.: PCT/EP08/59087

§ 371 Date: Jun. 8, 2010

(30) Foreign Application Priority Data
Jul. 24, 2007 (DE) 10-2007-034-329.0

(51) Int. Cl. G01S 13/00

(52) U.S. Cl. 342/175

(57) ABSTRACT

A radar device, particularly for measuring a speed above ground, includes a high-frequency circuit and an antenna. It is provided that the high-frequency circuit is arranged as a high-frequency chip, which has a plurality of antenna outputs, which are connected to the horn antennas via the antenna lines.

### FIELD OF THE INVENTION

The present invention relates to a radar device.

### BACKGROUND INFORMATION

Radar devices are known, in particular for measuring the speed above ground of a motor vehicle. They are used, for example, to supply driver assistance systems and/or safety systems in motor vehicles with data concerning the motion behavior of the motor vehicle; in particular, driving dynamics control systems are to be supplied with data required for their operating guidance, that relate to a possible understeering or oversteering of a vehicle. This makes necessary as accurate as possible a recording of the speed, the travel direction and the angle between the travel direction and the longitudinal axis of the vehicle, that is, the so-called attitude float angle. For the purpose of doing this, DE 10 2005 021 226 describes a device for the contactless speed measurement of a vehicle, using a bifocal, folded antenna device on a vehicle, which is designed for the emission of emitted signal waves in at least two different directions and for receiving reflected signal waves corresponding to the emitted signal waves from the at least two different directions, as well as a signal processing device directed to this, for generating at least one signal as a measure of a speed in at least one of the different directions, based on the emitted signal waves and the corresponding reflected signal waves. The disadvantage of this is that a bifocal, folded antenna device is used that has a large design, the additional devices required for generating, emitting and receiving the corresponding signal waves being present as separate components which are connected, for example, via wave guides, to the bifocal, folded antenna device, or a high frequency chip having to be situated for each direction in the area of the bifocal, folded antenna device. Besides their relatively great space requirement, it is disadvantageous that such designs are not suitable for cost-effective mass production. Bifocal, folded antenna devices need large high-frequency substrate areas, whereas, in conventional arrangements, the dissipation of the antenna loss created does not enter into consideration.

### SUMMARY

Example embodiments of the present invention provide a radar device which avoids the disadvantages mentioned, and which has particularly a design suitable for mass production and cost-effective manufacturing.

A radar device is proposed for this, especially for measuring a speed above ground, having a high-frequency circuit and an antenna, it being provided that the high-frequency circuit is arranged as a high-frequency chip which has a plurality of antenna outputs that are connected to horn antennas via antenna lines. The high-frequency circuit is executed as an high-frequency chip, that is, in an integrated design, so that for emitting, receiving and evaluating signal waves, only very few components are still required. This high-frequency chip has a plurality of antenna outputs, which are connected to horn antennas via antenna lines. Horn antennas, in this instance, are antennas which have a substantially horn-shaped contour. The bifocal, folded antenna device is not required, in this instance.

In example embodiments of the present invention, the antenna lines are arranged in each case as at least one circuit-board conductor running on a circuit board. The antenna lines are therefore arranged in such a way that they form circuit-board conductors on a circuit board, as a result of which wiring or wave guides are not required.

In example embodiments, the antenna lines have a patch at each end. The patch is used to radiate the signal waves, for which each patch has a horn antenna assigned to it. In particular it is provided, in this instance, that the horn antennas are situated above the patch, and the latter irradiates the horn antenna.

In example embodiments, the circuit board is a polyimide foil. Kapton is used as such a polyimide foil, for example; it is used both as a circuit board and as a high-frequency-suitable carrier substrate for antenna feeding. Such circuit boards are cost-effective and easy to manufacture using conventional methods, particularly also with respect to the antenna lines arranged as circuit-board conductors.

In example embodiments, the antenna line is a microstrip, a grounded coplanar strip or a symmetrical line. Depending on the application and according to a preferred frequency range, the antenna lines are arranged as microstrips as a result, that is, of the kind that, on one side of the circuit board a single circuit-board conductor leads to the patch, and on the opposite side of the circuit board a correspondingly large ground field is situated. As still another example embodiment one might consider a grounded, coplanar strip, a ground conducting circuit-board conductor being additionally positioned around both sides of the above-described example embodiment as a microstrip, for additional screening. One might also consider a symmetrical line, as known from general signal technology.

In example embodiments, four antenna outputs are provided, to which four antenna lines are connected that run in such a way that they form a cruciform structure, in which an antenna line in each case includes an angle of 90° with a respectively adjacent antenna line. As a result, the antenna lines, among one another, form a cross on the circuit board, the high-frequency chip being situated in the center of the cruciform structure, and the respective patch is situated at the respective ends of the antenna lines. In this manner, four radiating devices and receiving devices are arranged in connection with the respective antennas, which permit radiation directed corresponding to the respective requirements and the corresponding receiving of the signal waves. At the same time, an arrangement is implemented that is relatively small and easy to manufacture.

In example embodiments, four horn antennas are provided, which are situated in the vicinity of the corners of an imaginary square. The corners of the imaginary square, in this case, correspond to the situation of the patches in the abovementioned cruciform structure of the four antenna lines. Accordingly, the imaginary square is shifted by 45° with respect to the cruciform structure in such a way that the horn antennas are in each case situated, with their respective focal point, for example, over the respectively assigned patch. In this manner, the radiation of the signal waves of the patch takes place into the respectively assigned horn antenna, an appropriate directional effect being achieved by the geometry and the alignment of the horn antenna within the abovementioned geometric structure.

In example embodiments, the high-frequency chip is situated between the circuit board and a carrier. The high-frequency chip is located on one side of the circuit board, in such a way that it projects above the circuit board by its height, or rather by the installation space it requires. Subsequent to the high-frequency chip there is a carrier that is used as the support device for the radar device, and in particular accommodates the abovementioned components in such a way that that they are fixed in the desired situation. Accordingly, the circuit board is accommodated by the carrier, with its topside carrying the chip.

In example embodiments, the carrier forms a heat sink for the high-frequency chip. To do this, the carrier is coupled thermally to the high-frequency chip, such as being adhered to it by a heat-conducting adhesive. The carrier is also arranged as a metallic carrier, for instance, as a component produced in a metal injection molding method of a magnesium or aluminum alloy, or an alloy having such metals. For the appropriate accommodation of the high-frequency chip, the carrier has a suitable structure, for instance a support recess that corresponds to the height of the high-frequency chip, and that is preferably also adapted to its shape, into which the high-frequency chip is able to be adhered, especially when the carrier is mounted in the area of the circuit board fitted with components. This brings about an optimum cooling of the high-frequency chip, since the metal mass on the chip is large and a very small heat resistance is present between the high-frequency chip and the heat sink. In the example embodiment described, only a very minimum adhesion gap is required between the high-frequency chip and the carrier, which is bridged using an heat conductive adhesive.

In example embodiments, the carrier has a cooling fin structure. What is meant by this is that the carrier has cooling ribs, particularly on the outside at the end face, as is familiar in the related art, so that a great enlargement of the heat-radiating surface is achieved in the area of these end faces. The carrier is preferably produced from a material described above, that ensures particularly good heat conduction. The heat loss of the high-frequency chip is thereby given off via the carrier to the environmental air.

In example embodiments, the carrier forms parts of the horn antenna. As a result, the horn antennas that are to be positioned over the respective patches, are formed by a geometrical structure, such as horn contour-like/conical recesses in the carrier, which become wider, starting from the circuit board and going upwards, to the other side of the carrier. At the topside of the carrier, that is, the side facing away from the circuit board, the opening of the horn structure in the carrier is at its largest, so that, in that location, a horn aperture is formed, whereas on the bottom side of the carrier, facing the circuit board, it is at its smallest. Furthermore, this bottom side of the carrier takes up the abovementioned space for accommodating the high-frequency chip and for its adhesion to the carrier. Because of this arrangement, the carrier not only fulfills the function of heat sink and heat dissipation for the high-frequency chip, but at the same time, in a comparatively small space, forms the horn antennas for operating the radar device.

In example embodiments, a cover is assigned to the carrier, which has horn lenses for the horn antennas and/or fills the horn antennas dielectrically. The cover is situated at the topside of the carrier, so that it covers the carrier. In this instance, the cover may have horn lenses, that is, devices for bundling or scattering the signal waves that exit from the horn antennas and/or fill the horn antennas at least partially dielectrically, that is, with a dielectrically acting material of which the cover is preferably made. It is provided, in this instance, for example, that at the bottom side of the cover, that is, on the side that is opposite to the corresponding horn lenses, a structure is arranged that is form-matched to the horn antennas formed in the carrier, which extends into the horn antennas formed on the carrier and fills them. In this manner, once more a diminution may be achieved of the design, relative to the antenna dimensions that are usual and are known from the related art for the frequency ranges used. In this instance, the horn lenses are used for the bundling or directing of the signal waves, so that the latter are able to be radiated in the direction desired and required for the respective application purposes, and are able to be bundled in the process.

In example embodiments, it is provided that, on the side of the circuit board facing away from the high-frequency chip, a high-frequency fixing part is situated which forms areas of the horn antennas. On the side of the circuit board facing away from the high-frequency chip, that is, on the bottom side of the circuit board, a fixing part is situated which, on the one hand, fixes the circuit board mechanically between itself and the carrier, for which the high-frequency fixing part is able to be screwed together, for example, with the carrier and all the way through the circuit board or even adhered together (in the first case, the circuit board preferably has recesses which are able to be penetrated by the screwing mechanism or by fixing bolts). On the other hand, the high-frequency fixing part is used to provide regions of the horn antennas in such a way that that structure of the horn antenna, as applied in the carrier, continues in the region of the high-frequency fixing part. In a sectional representation it would accordingly look as if the circuit board were penetrated by the geometrical structure of the horn antenna. A shortback is preferably formed in the high-frequency fixing part, that is, a high-frequency short circuit region that lies exactly underneath the patch of the respective horn antenna. The entire antenna is accordingly formed from the patch located on the circuit board, the shortback situated under the patch in the high-frequency fixing part, and the horn structure of the horn antenna located in the carrier, above the patch.

In example embodiments, the high-frequency chip is connected in flip-chip mounting. By doing this, one is able to provide a quite particularly advantageous small design of the high-frequency chip on the circuit board, because all, or almost all the required high-frequency circuits on the high-frequency chip are integrated, and the latter is arranged as a silicon-germanium chip, for example. The high-frequency chip is arranged as an open, not housing-enclosed flip-chip, so that it is able to be connected in flip-chip mounting, that is, soldered by solder bumps directly onto the circuit board, and then, in the mounting, adhered with its back side to the carrier using a heat conducting adhesive. In this connection, a recess is preferably provided in a region of the high-frequency fixing part opposite the high-frequency chip, so that possible geometrical tolerances of the bumps are able to be compensated for by the flexibility of the circuit board, which is preferably made of polyimide foil, for instance, Kapton, since the bumps are able to expand slightly into the recess. In this manner, a completely noncritical mounting and adhesion is made possible, of the high-frequency chip on the carrier. By doing this, in particular geometrical tolerances with respect to the adhesion gap between the carrier and the high-frequency chip may also be compensated for, since the circuit board is able to yield in the low range in which such tolerances are liable to occur in mass production.

Corresponding contact differences are bridged by a deformation of the circuit board during the mounting of the high-frequency fixing part, for which the high-frequency fixing part has the appropriate recess in the opposite position to the high-frequency chip.

Example embodiments of the present invention are explained in the following with reference to the figures.

### BRIEF DESCRIPTION OF THE DRAWINGS

FIG. 1 is an exploded representation of the radar device,

FIG. 2 is a sectional representation through the radar device and

FIG. 3 is a top view onto the circuit board, having a mounted high-frequency chip and having microstrip antenna lines.

### DETAILED DESCRIPTION

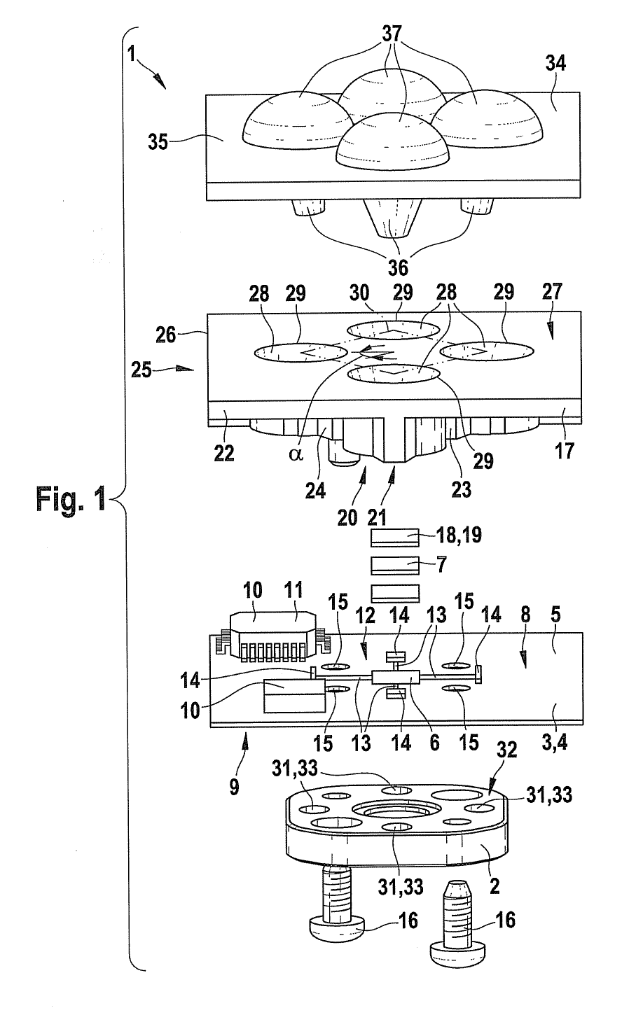

FIG. 1 shows a radar device 1 in an exploded representation. Radar device 1 has a high-frequency fixing part 2, which is situated below the bottom side of a circuit board 3 and supports circuit board 3 at its circuit board bottom side 9. Circuit board 3, which is made as a polyimide foil 4, namely of Kapton 5, has on its circuit board topside 8 an accommodation region 6 for a high-frequency chip 7, accommodation region 6 being situated substantially centrically on circuit board topside 8. On circuit board topside 8, and if necessary also on circuit board bottom side 9, circuit board 3 carries additional components 10, that are required for executing the electric circuit of radar device 1, particularly also for the purpose of contacting, for instance, using a contacting device 11, by which the radar device is connected to electrical or electronic circuits lying outside of itself, and is particularly able to be supplied with operating voltage. From the substantially centrically situated accommodation region 6 on circuit board topside 8, antenna lines 13 extend in the form of a cruciform structure 12, which, at their end, lying within circuit board topside 8, each have a patch 14. Between one another, antenna lines 13 include an angle of 90° in the plane of circuit board topside 8, whereby they form cruciform structure 12 mentioned. Approximately in the area of its respective bisector, that is, at a 45° angle between two antenna lines 13 respectively, there are mounting recesses 15 in circuit board 3, which are able to be penetrated by screw bolts 16, so as to be able to screw together high-frequency fixing part 2 with carrier 17 that is situated on top of circuit board 3, circuit board 3 being situated between high-frequency fixing part 2 and carrier 17. In this connection, high-frequency chip 7 is adhered to a supporting recess 20, that is adjusted to its height, that is, for instance, adapted to its shape, on carrier bottom side 21 of carrier 17, using an adhesive layer 18, namely heat-conducting adhesive 19. This adhesion is performed only during the course of final assembly of radar device 1, after high-frequency chip 7 has been soldered by way of flip-chip mounting to accommodation region 6 using solder bumps that are not shown here. Carrier 17, that is preferably produced of a magnesium-aluminum alloy 22 and by way of a metal injection molding method, forms a heat sink by this adhesion for high-frequency chip 7, for the dissipation of the heat given off/antenna loss created in high-frequency chip 7. For this, the carrier has a cooling rib structure 23 in its side regions 24 and at its end faces 25, that promotes the release of the waste heat to the environmental air. Preferably, cooling rib structure 23 is developed in such a way that it does not project beyond an outer circumference contour 26 of a carrier topside 27, but recedes from it. Preferably, carrier topside 27 has an area dimensioned corresponding to circuit board 3, which means that, in cross section, carrier 17 is substantially coincident with circuit board 3. As opposed to that, cooling rib structure 23 of carrier 17 recedes, so that cooling rib structure 23 does not project past outer circumference contour 26, but advantageously has the effect of promoting a good heat dissipation within the dimensions and ground plan specified by the dimension of circuit board 3. Carrier 17 has four horn antennas 28, which are taken out of the carrier material as open regions. Accordingly, at carrier topside 27 there is a horn aperture 29, in each case, while at carrier bottom side a corresponding horn neck is arranged, which is not shown. Horn antennas 28 are situated in the area of the corners of an imaginary square 30, this square 30 being shifted by an angle of 45° with respect to cruciform structure 12 that is located on circuit board 3. This brings about a position of the horn necks, not visible in this illustration, of each horn antenna 28 exactly in the area of a patch 14, so that each patch 14 radiates exactly into a horn antenna 28. In high-frequency fixing part 2, that is situated beneath circuit board 3, in continuation of horn antennas 28, and thus forming a part of horn antennas 28, there are depressions 31 which, on their part, lie exactly below a patch 14, respectively.

Depressions 31 are closed at an end, however, that is, they are only open at a fixing part upper side 32 facing circuit board 3, and thus they form a shortback 33, which prevents radiation of radar waves in an undesired direction counter to course of the horn, and leads to the direction of radiation into the respective horn antennas 28. A cover 34, made of an electrically nonconducting material 35, is set upon carrier 17, namely on carrier topside 27. Cover 34 has dielectric material structures 36, which are substantially adapted as to shape to the contour of horn antennas 28 within carrier 17, and which fill horn antennas 28 in the area of carrier 17 at least in regions, when the cover is put on. Furthermore, the cover has horn lenses 37, in prolongation of the contour of respective horn antennas 28 and of dielectric material structure 36, which are arranged approximately dome-shaped, and which permit bundling of, or giving directional information to the radar waves exiting from respective horn antenna 28.

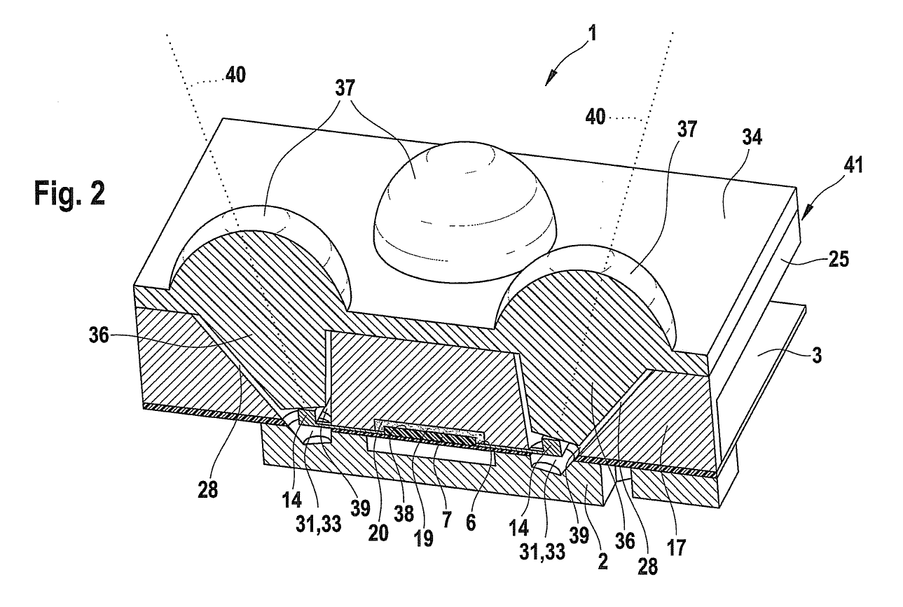

FIG. 2 shows a sectional representation through mounted radar device 1. In this case, circuit board 3 is held between high-frequency fixing part 2 and carrier 17. On circuit board 3, high-frequency chip 7 is soldered on to accommodation region 6, which is in turn adhered with its chip topside 38 in support recess 20 of carrier 17, using an heat-conducting adhesive 19. Carrier 17 has horn antennas 28 which are substantially filled by dielectric material structures 36 of cover 34, and which continue on the upper side of the cover in horn lenses 37. High-frequency fixing part 2 has depressions 31 in continuation of horn antennas 28, which each act as shortback 33. Horn antennas 28 and depressions 31 are situated going over into each other in their geometry in such a way that patches 14 situated on circuit board 3 lie exactly in a horn neck 39 arranged in the course of horn antenna 28, on the lower side of carrier 17. In this instance, Horn antennas 28 are developed in such a way that each horn antenna 28 radiates into its own specific direction. This specific direction may be determined in each case according to the requirements of the respective application; in the present exemplary embodiment, each horn antenna 28 radiates in a direction so that a radiation axis 40 is not perpendicular to circuit board 3 but is inclined in the direction of the respectively closest end face 25 of carrier 17 or of its closest longitudinal side 41.

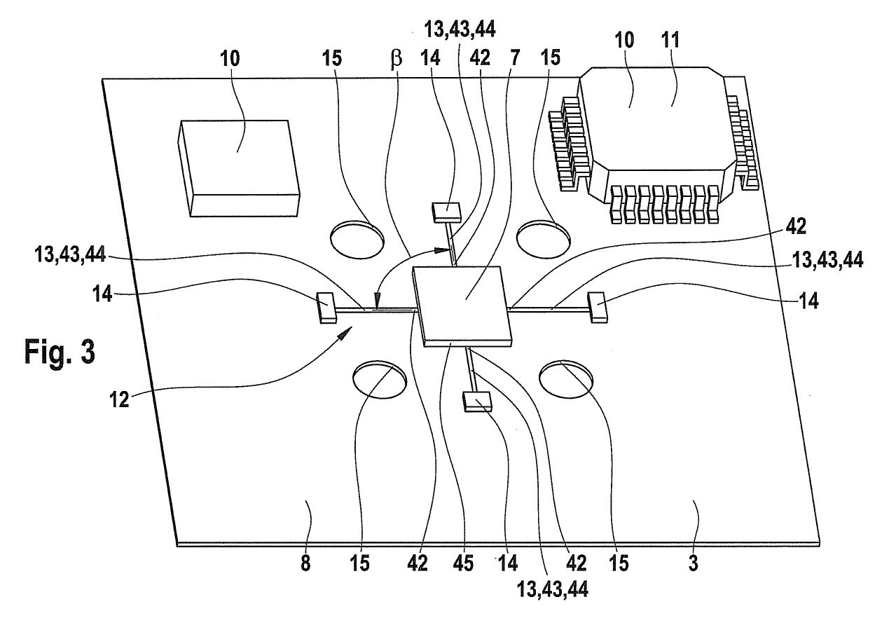

FIG. 3 shows circuit board 3 of above-described radar device 1 that is not shown here. Circuit board 3 has high-frequency chip 7, substantially centrically on its circuit board topside 8, and it has four antenna outputs 42, to which in each case one antenna line 13 is assigned for connecting antenna output 42 to respectively assigned patch 14. Antenna lines 13 are arranged, in this instance, as circuit board conductor 43 running on circuit board 3, namely in an execution as a microstrip 44. Besides the arrangement as microstrip 44, in particular, arrangements as grounded coplanar strips (not shown) are possible, or as symmetrical lines. Antenna lines 13, namely circuit board conductors 43, form cruciform structure 12 on circuit board 3, in such a way that each antenna line 13 includes an antenna lines angle β of 90° with its closest neighboring antenna lines 13. In this context, one antenna lines 13 is assigned to each narrow side 45, in such a way that on each narrow side 45, an antenna line 13 of cruciform structure 12 arises and leads to a patch 14. This makes possible as advantageous as possible a signal guidance without undesired mutual influencing of individual antenna lines 13 and patches 14. Between individual antenna lines 13, mounting recesses 15 have been applied onto circuit board 3, which are used by screw bolts 16, described in FIG. 1 and not shown here, for mounting high-frequency fixing parts 2 described in FIG. 1, circuit board 3 being fixed between high-frequency fixing part 2 and carrier 17, that is also not shown here. Besides high-frequency chip 7 and antenna lines 13 required for signal radiation and patches 14, circuit board 3, if necessary, has additional electronic components 10, especially peripheral components and/or a contacting device 11 for connecting the electronic circuit on circuit board 3 to other electronic circuits outside radar device 1 and for supplying the latter with operating voltage.

1-14. (canceled)

15. A radar device, particularly adapted to measure a speed above ground, comprising:
a high-frequency circuit; and
an antenna;
wherein the high-frequency circuit is arranged as a high-frequency chip which has a plurality of antenna outputs, which are connected to horn antennas via antenna lines.

16. The radar device according to claim 15, wherein the antenna lines are each arranged as at least one circuit board conductor extending on a circuit board.

17. The radar device according to claim 15, wherein the antenna lines each have a patch at their end.

18. The radar device according to claim 16, wherein the circuit board is a polyimide foil.

19. The radar device according to claim 15, wherein the antenna line is at least one of (a) a microstrip, (b) a grounded coplanar strip, and (c) a symmetrical line.

20. The radar device according to claim 15, wherein four antenna outputs are provided, to which four antenna lines are connected that extend in such a way that they form a cruciform structure, in which an antenna line in each case includes an angle of 90° with a respectively adjacent antenna line.

21. The radar device according to claim 15, wherein four horn antennas are provided which are situated in an area of corners of an imaginary square.

22. The radar device according to claim 16, wherein the high-frequency chip is situated between the circuit board and a carrier.

23. The radar device according to claim 22, wherein the carrier forms a heat sink for the high-frequency chip.

24. The radar device according to claim 22, wherein the carrier has a cooling rib structure.

25. The radar device according to claim 22, wherein the carrier forms parts of the horn antennas.

26. The radar device according to claim 22, wherein a cover is assigned to the carrier, which at least one of (a) has horn lenses for the horn antennas and (b) fills the horn antennas dielectrically.

27. The radar device according to claim 16, wherein a high-frequency fixing part is situated on a side of circuit board facing away from the high-frequency chip, which forms areas of the horn antennas.

28. The radar device according to claim 15, wherein the high-frequency chip is connected in flip-chip mounting.
